(19) United States
(12) Patent Application Publication
(10) Pub. No.: US 2016/0201150 A1
(43) Pub. Date: Jul. 14, 2016

(54) MILL JUICER FOR PLANTS

(71) Applicant: Isaías RODRÍGUEZ CISNEROS, León, Guanajuato (MX)

(72) Inventor: Emmanuel RODRÍGUEZ ALCARAZ, León, Guanajuato (MX)

(21) Appl. No.: 14/912,637

(22) PCT Filed: Jul. 17, 2014
(86) PCT No.: PCT/MX2014/000109

§ 371 Date: Feb. 18, 2016

(30) Foreign Application Priority Data
Aug. 20, 2013 (MX) MX/A/2013/009588

(51) Int. Cl. C13B 10/06; B02C 4/28; B02C 4/08

(52) U.S. Cl. CPC C13B 10/06; B02C 4/08; B02C 4/28

(57) ABSTRACT

The invention relates to a mill juicer for plants, in which the transmission of power to the mill is novel owing to the design of the structure on which the juice extraction mechanisms are mounted, the elements that allow the set of rollers to rotate. In order to absorb the misalignment resulting from the operation and the construction of the mill, the invention includes the use of efficient elements, for example: self-aligning bearings mounted on a bearing block designed to support the loads of the mill, while allowing misalignment and maintaining lubrication of the bearing. The assembly of gear motors is mounted on the solid shaft of each of the rollers, the arrangement of three rollers rotates in opposing directions and having finishes for directing the material to a central zone and producing greater friction between the material to be processed and the rollers, thereby providing an efficient juice extraction.

### TECHNICAL FIELD OF THE INVENTION

The present invention is related to a mill, particularly to a mill juicer for plants such as Agavoideae or sugar canes and alike to obtain their juice.

### OBJECT OF THE INVENTION

The object of this invention is to increase the mechanical efficiency of a mill for plants by compensating the misalignment between the shafts of the extraction elements in a mill when the juice of the plants is extracted and at the same time the administered energy is used by the impulse sources.

### BACKGROUND OF THE INVENTION

There are devices to extract juice from plants such as the devices to extract sugar cane juice; examples of these kinds of inventions are known in the document CU22374 (A1), dated Dec. 31, 1996 granted to DISEÑO MECANICO DEL MINISTERIO (CU), this invention is related to the field of sugar cane production, particularly with milling factories and more specifically with mills intended to grind sugar cane to extract its juice from its cells. The objective of the above cited invention consists of the constructive design of a four-rollers mill where its integral setting is achieved in a continuous manner and is controlled from the exterior; to increase the bearing bases and the location possibilities for the fourth roller; to protect the bearings' working zone; optimize the configuration of the original, the lids and the complementary structures, as well as, the mechanical solutions applied to the different mill attachments. This mill possesses devices made up of an oppressing plate, a nucleus and a graduated ring, which make possible the adjusting of the mill's input and output settings, as well as, the feeding entry and the position of the central blade in a continuous form and with a level of precision of up to hundredths of a millimeter. In the mill there have been applied modifications in the original's profile and in the sugar cane side lid by which the surfaces are expanded that function as guide and support to the bearings of the fourth roller, providing an effective range of feeding entries that go from an entry zero up to more than four times the entry setting of the mill, further allowing that the fourth roller be maintained “geared” the whole time to the sugar cane roller, bearings of all its rollers have tightness elements which increase the life of the collars and bearings, and habilitate the recovery of the lubricant without contamination. Further to the modifications applied to the original, the lids and complementary structures, as well as, the coupling forms of said elements among themselves make it possible to simplify, humanize and economize the assembly and disassembly and the maintenance of the mill as a whole.

Other known inventions is the one granted to FIVES-CAIL BABCOCK, in its model of publication number ZA200903905 (A), dated Dec. 14, 2007, which consists of providing a mill that only has 2 press rollers that roll counterclockwise; at least two rollers can have peripheral, annular grooves, intended for the flow of the juice extracts. Both press rollers are found coupled to one another, especially in 52 beams, which allows an efficiency five times greater.

Another example of this kind of devices is taught in the document MXPA03010191 granted to BHAUSAHEB BEPURAO KINAM [IN] dated Mar. 16, 2004, consisting of providing an improvement to the sugar cane mill of two grinding rollers wherein the hydraulic cylinder to load the upper roller is assembled in a pivoting and flexible manner and in the far end of the elevation bearing to allow the upper roller free floating and reduce the possibilities of hydraulic seal failure/considerably system, thus under timely maintenance of the mill, there is a greater productivity.

Also known are similar inventions from the documents ES8606794 (A1) and CU34979(A).

### TECHNICAL PROBLEM TO SOLVE

Even though plant extractors are known such as mills for plants such as cane sugar or Agavoideae, said inventions do not contemplate the solution to the problem of compensating the misalignment between the rotating shafts of the rollers that conform them, which generates an irregular wear in the transmission gearing, as well as in the loading bearings known as bushings or metals, wherein the misalignment occurs during the operation of the mill. The aforementioned is observed when a driven gear alters its alignment with respect to the driven gear's shaft, so that the contact between the teeth is carried out in an unsuitable contact zone far from the passing diameter of the teeth, which reduces the efficiency and life of the potency transmission and negatively affects the components due to the operation thereof in unsuitable design conditions. Because of the great torsion demand from the transmission to roll the rollers, driven motors of great size are required and therefore a transmission of proportional dimensions for said motor and operation conditions requires a robust foundation to ensure the operation and application of the energy.

### BRIEF DESCRIPTION OF THE INVENTION

In order to solve the problem of compensating the misalignment of the roller's rotating shafts in a mill for plants such as sugar cane or Agavoideae, a series of groupings that allow the oscillation of the shafts of said rollers during operation has been developed. Said groupings comprise an arrangement of bearing blocks that oscillate the position according to the load in the mill, which allow a certain ball and socket joint-type spherical freedom; moreover, each of the shafts is coupled to an impulse source of independent function and said impulse source is found anchored to the structure by a supporting arm anchored to the impulse source and at the same time allows the oscillation of movement by operation over the shafts of the mill. It is necessary that the teeth have a means to ease their traction to the rollers and lead to material to be grinded to the area of better efficiency of the equipment, for which the machine in the length of the roller has a tilting to form tips that are inserted into the material to be processed and take it to the area of extraction.

### BRIEF DESCRIPTION OF THE FIGURES

FIG. 1.—Shows a perspective view of the mill for plants;

FIG. 2.—Shows a top view of the mill for plants;

FIG. 3.—Shows a perspective view of the impulse means for the rollers of the mill for plants;

FIG. 4.—Shows a perspective view of the support structure of the mill for plants;

FIG. 5.—Shows a perspective view of a base of rollers from the supporting structure of the mill for plants;

FIG. 6.—Shows a perspective view of a sliding bearing of the mill for plants;

FIG. 6A.—Shows a transversal cut of a bearing's shell;

FIG. 7.—Shows a perspective view of the sliding bearing's disassembly from the mill for plants;

FIG. 8.—Shows a perspective view of the assembly of a roller of the mill for plants;

FIG. 8A.—Shows a perspective view of a roller's pin arrow;

FIG. 9.—Shows a perspective view of a roller of the mill for plants;

FIG. 10.—Shows a perspective view of a portion of the surface of a roller of the mill for plants;

FIG. 10A.—Shows the view of the transversal cut of a roller of the mill;

FIG. 11.—Shows a perspective view of the assembling of the impulse means with the roller and the base of rollers of the mill for plants;

FIG. 12a.—Shows a perspective view of the assembling of the base and entry rollers of the mill for plants;

FIG. 12b.—Shows a perspective view of the assembling of the base and output rollers of the mill for plants;

FIG. 13.—Shows a perspective view of the assembling of the supporting arm at the base of the rollers of the mill for plants;

FIG. 14.—Shows a perspective view of the supporting arm.

FIG. 15.—Shows a perspective view of the assembly of a gear motor.

FIG. 16.—Shows a top view of the upper and lower rollers.

### DETAILED DESCRIPTION OF THE INVENTION

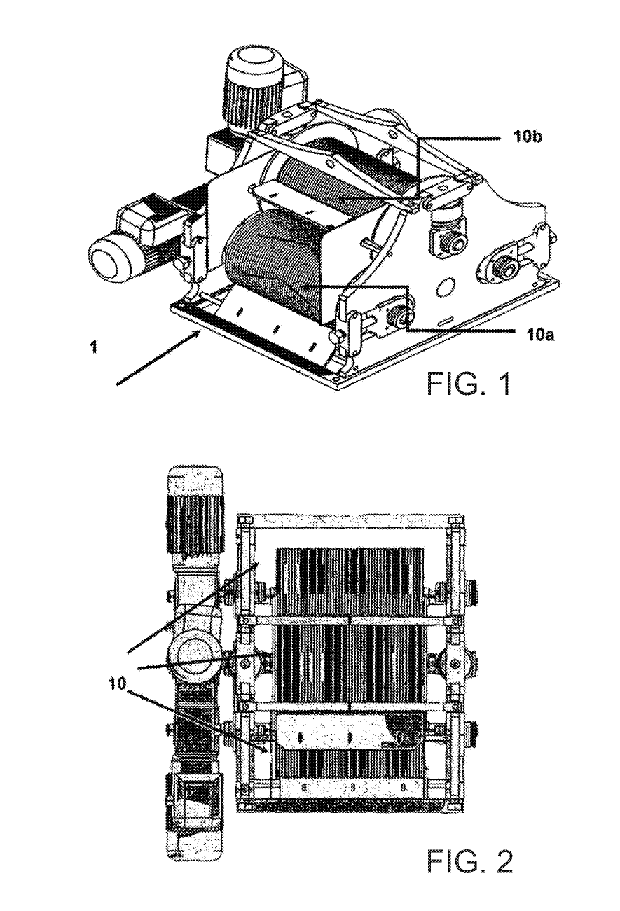

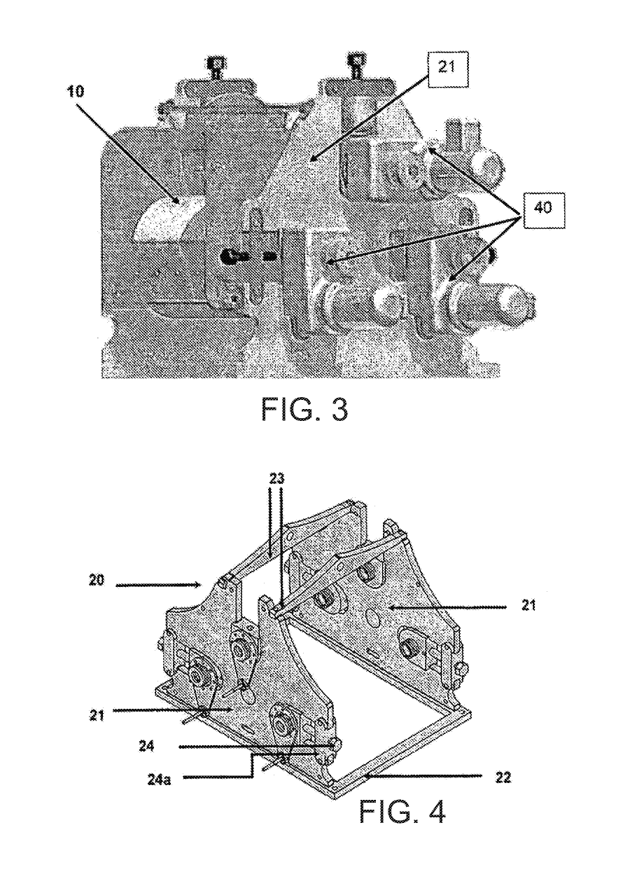

The present invention is related to a mill (1) as shown in FIG. 1, composed of an arrangement of rollers (10), which for illustrative purposes can be an arrangement of three rollers in a triangular arrangement: said arrangement of rollers (10) is assembled in a support structure (20) that constitutes the loading structure of these components and mainly the arrangement of rollers (10). Each one of these rollers (10) has a gear motor assembly (40), so that it applies an impulse independently of each one of them, apart from passing the power directly to the rollers (10), and also, to vary the spin rate if improving the production of this mill (1) is required.

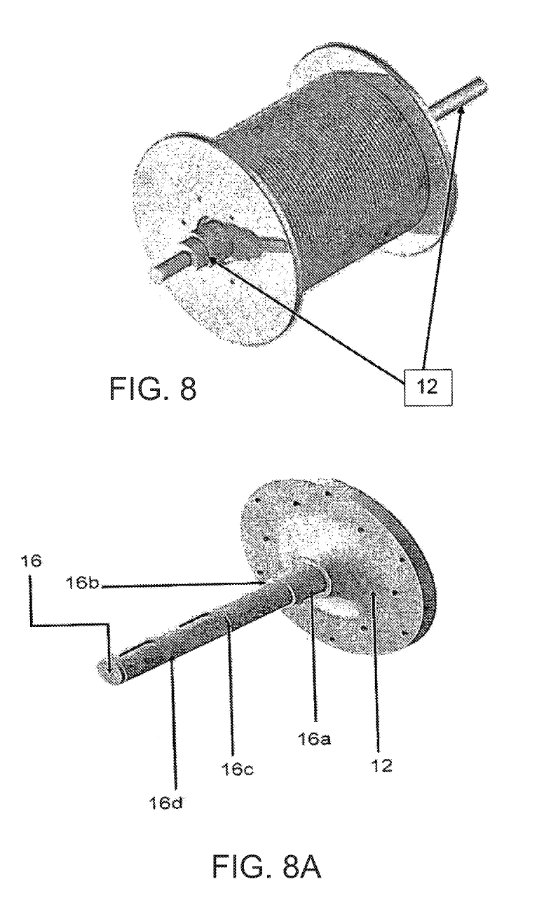

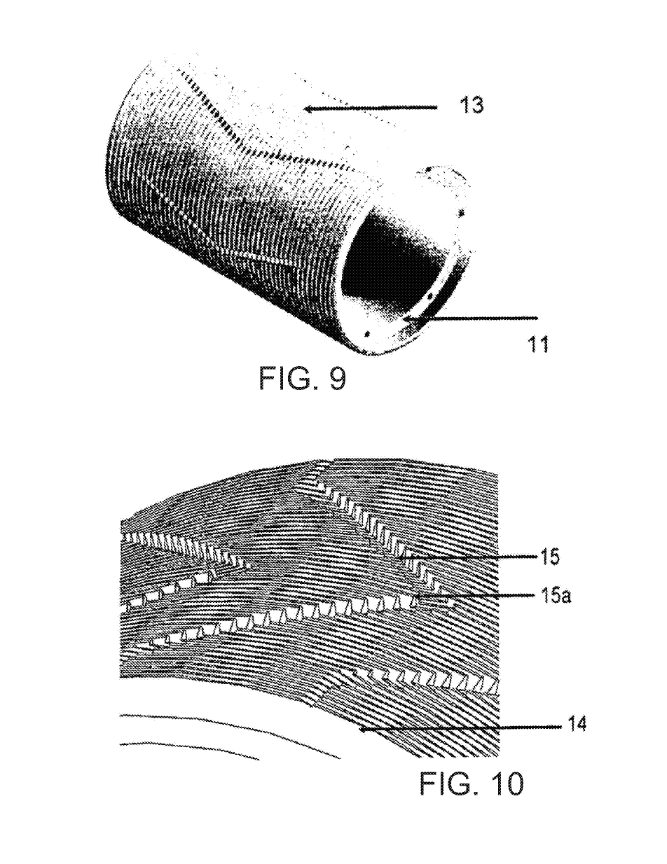

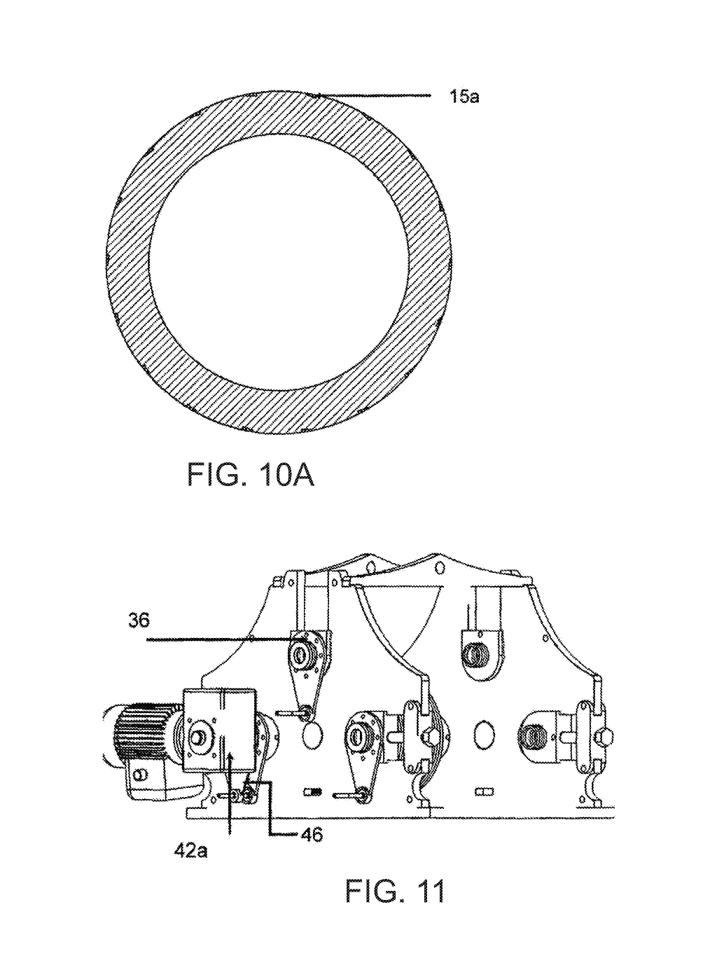

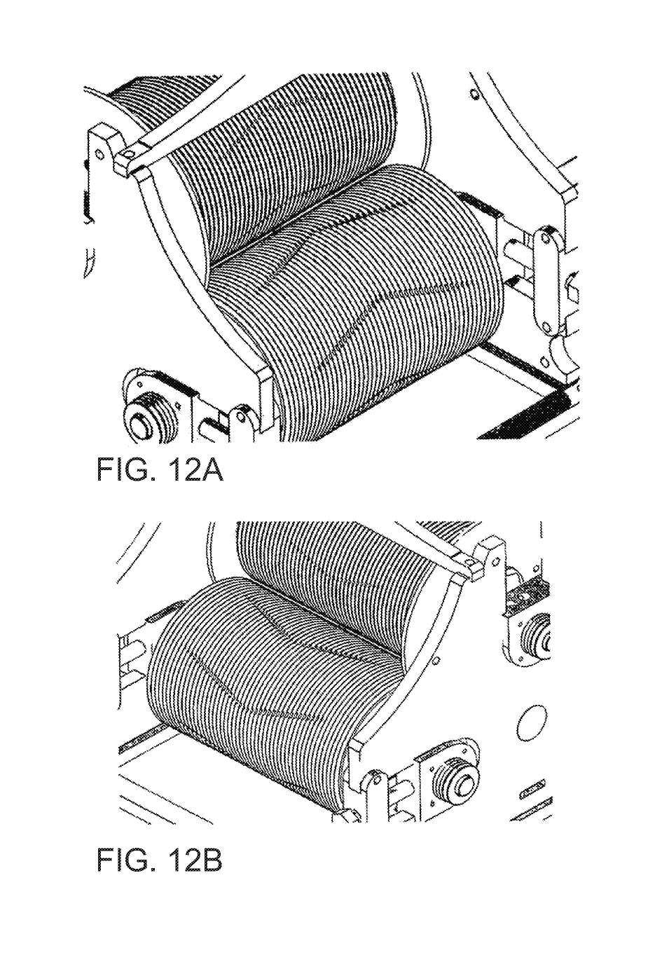

Each one of the rollers in the arrangement of rollers (10) as shown in FIG. 8 and FIG. 9, comprises a central bearing (11) with a roller arrow (12) that makes up arrow spikes (16), which settle in the bearing blocks (30) that hold the roller (10) so it can rotate. The central bearing (11) has a series of teeth (13) that part from an initial bearing (14), as known in the art, which consist of perimetral rings, with a transversal section in the shape of a trapeze as is known in the art, as shown in FIGS. 9 and 10; the distance between these teeth (13) and an adjacent teeth (13) generates a reduction (13a) as shown in FIG. 16, in a suitable spacing to allow the pass of one of the teeth of at least one roller (10) that rotates adjacently when the mill is in operation (1). Over the series of teeth (13) there results a pattern of transversal cuts (15) distanced between each other, as shown in FIG. 9 and FIG. 10, wherein this transversal cut (15) does not interfere with the central bearing (11), so that it has an angled line such as a drawing for a tire, that is produced in a convenient number to the periphery of the roller (10) and that extends in a tilted manner from each border of the central bearing (11) and converges in the center of the roller (10), so that, ideally, in the pair of top (10b) and bottom (10a) rollers exposed at the entry of the mill (1) the vertex of the transversal cut (15) in one of them is directed in opposite directions from the vertex of the transversal cut (15) of the adjacent roller (10), also in the pair of top (10b) and bottom (10a) rollers exposed at the output of the mill (1) the vertex of the transversal cut (15) in one of them is directed in the same direction to the transversal cut (15) of the adjacent roller (10), as can be seen in FIGS. 12a and 12b. This transversal cut (15) of the roller (1) as can be seen in FIG. 10A, makes a wall with an acute angle at the top border of the tooth (13) that makes up a tip (15a), so that with this transversal cut (15) the material's fibers to be processed are anchored to induce their passing between the rollers' arrangement (10). To favour the above, at the crest of the tooth (13) there is a coarse finish which could be present in the front of the teeth (13), known as knurling (not illustrated) to increase the roller's friction (10) with the material's fibers intended to be processed. The stroke of the angled line of the transversal cut (15) makes it possible that the material be concentrated at the center of the roller (10) thereby the misalignment that may be present during the operation of the mill (1) is reduced when the material to be processed is directed to the center of the bearings (11) of the rollers' arrangement (10); moreover, with the form of this stroke there is a greater gaining of the juice volume extracted, when it is directed to a lower central zone of the roller (10), directing the material from the ends to the center of the rollers (10) avoiding dispersion and improving collection.

Each of the arrow spikes (16) as shown in FIG. 8A, consists of an axis with a series of diameters of different dimensions according to the elements installed therein. There is a first spike diameter (16a) from a first dimension suitable to install a dust cover (34) that protects an end of the arrangement of the arrow spikes (16) with a bearing (35). Moreover, there is a second spike diameter (16b) of lesser dimension than the previous, but suitable to install a bearing (35) in the bearing block (30), a third spike diameter (16c) of lower dimension than the previous, but suitable to install a dust cover (34) that protects the opposite end of the arrangement of the arrow spike (16) with a bearing (35); at the free end of this third spike diameter (16c) a lock such as those known (not illustrated) is installed, which limits the movement of the reducer's carcass (42a), and lastly the arrow is extended (16d) to mount the impulse source that consists of a gear motor (40).

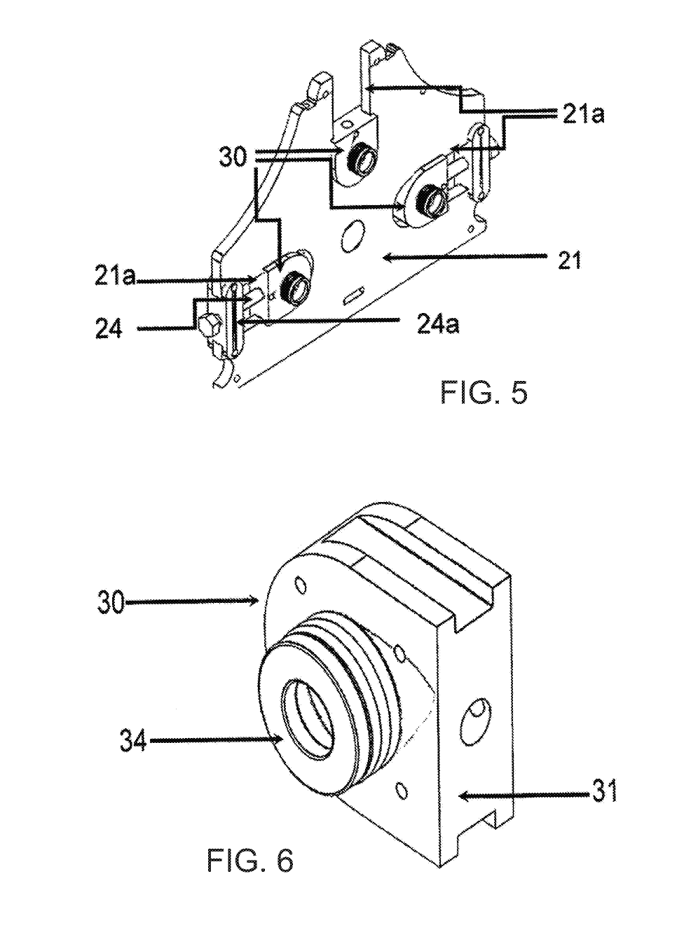

The support structure (20), as the one shown in FIG. 4 consists of a pair of rollers' bases (21), an inferior frame (22) and superior beams (23). Each of the rollers' bases (21) as shown in FIG. 5 is formed from solid plaques where there is a support for the arrangement of rollers (10). Each of these roller's bases (21) has an arrangement of sliders (21a) where some bearing blocks are housed (30) holding an end of the roller's arrow (12). In each end of the rollers (10) these are bound at the inferior border with the inferior frame (22) and the superior border by the top beams (23) in a suitable manner to give the support and rigidity necessary to the supporting structure (20) and of suitable features to take on the efforts to which the mill (1) is subjected. The location of the sliders (21a) allows placing a pair of bottom rollers (10a) in a first inferior plane and amongst these bottom rollers (10a) there is a third top roller (10b) in a superior plane, resulting in a triangular arrangement of the rollers (10), as can be seen in FIG. 1, FIG. 2. In this way there is a dimension between the perimeters of the teeth (13) of the bottom rollers (10a) and top rollers (10b), so that the material to be processed can pass through as can be seen in FIG. 16. As is known in the art of mills (1), in the reductions (13a) of the rollers (10) there are some brushes (not illustrated) to remove the compressed material that could be retained in these spaces.

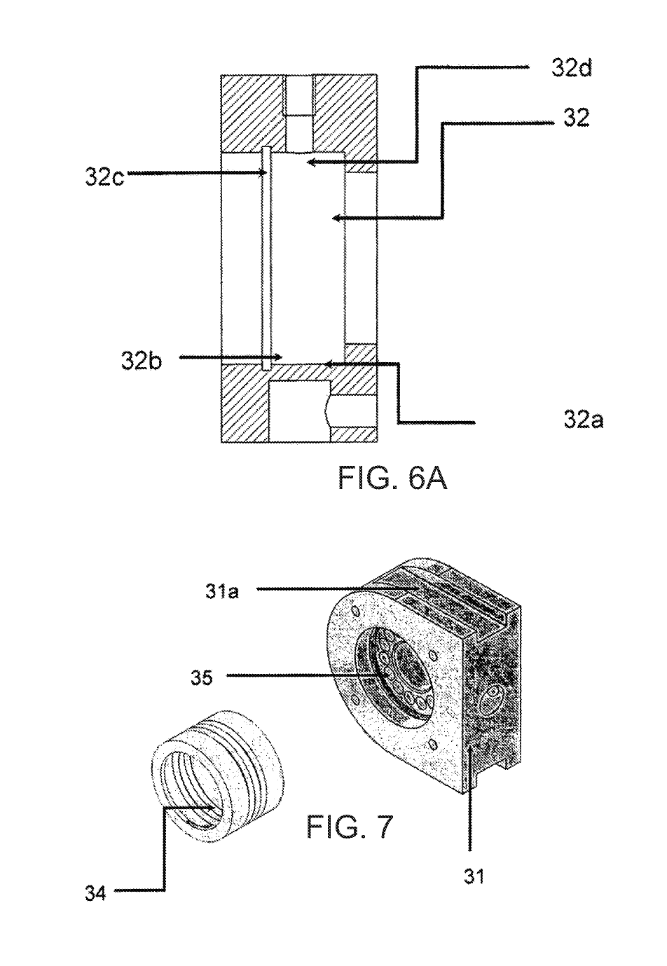

The bearing blocks (30) shown in FIGS. 6 and 7 represent the component that holds the rollers' arrow (12) and consist of a bearing block carcass (31) of dimension and material suitable to be housed in a sliding manner in the sliders (21a) at the rollers' bases (21). This bearing block (30) has a reduction of bearing block (31a) in the exterior of the bearing block's carcass (31) which functions as guide, so that it is of a suitable dimension to slide at the borders of the sliders (21a) in the rollers' bases (21) during their alternative movement. Moreover, the bearing block's carcass (31) has a bearing box (32) made up in its interior, of a suitable dimension to house a bearing (35). The bearing box (32) is conformed by a bearing seat (32a) consisting of a basin of a diameter that allows the adjusting of the bearing (35) in its interior and an oil box (32b) of suitable dimensions to contain a certain amount of lubricant and of a larger diameter that allows the free pass of bearing (35) until its operation position, as shown in FIG. 6A. As in known in the art, there is a lock opening (32c) to place a lock (not illustrated) to maintain the rotating position inside the bearing box (32). In a first end of the bearing box (32) there is a dust cover (34) as shown in FIG. 6 and FIG. 7 which forms a sealed sipper to contain the lubrication oil and at the same time provide a volume to house oil. Each of the dust covers (34) are enlarged with a first dimension end and suitable features to be housed in the opening of the bearing box (32) and a second end with an opening suitable to be adjusted in a sliding manner to the ends of the beams of the arrow (16) and with this allow its free rotation. The body of the dust cover (34) as shown in FIG. 7, is a type of bellow, which allows the absorption of deformation due to the misalignment of the exes with respect to the base structure (20) when found in operation. The bearing (35) is of the ball and socket joint-type known in the art, of dimensions and features suitable to the work environment where applied.

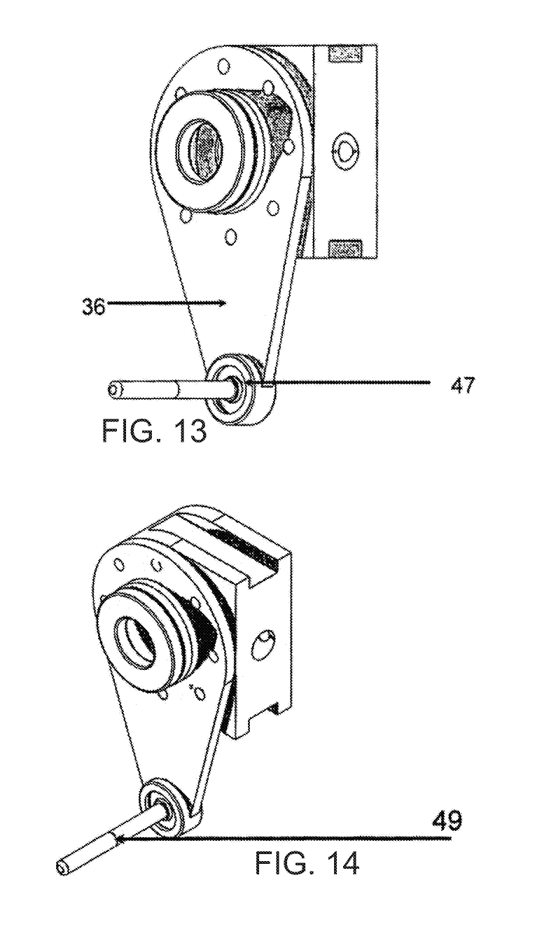

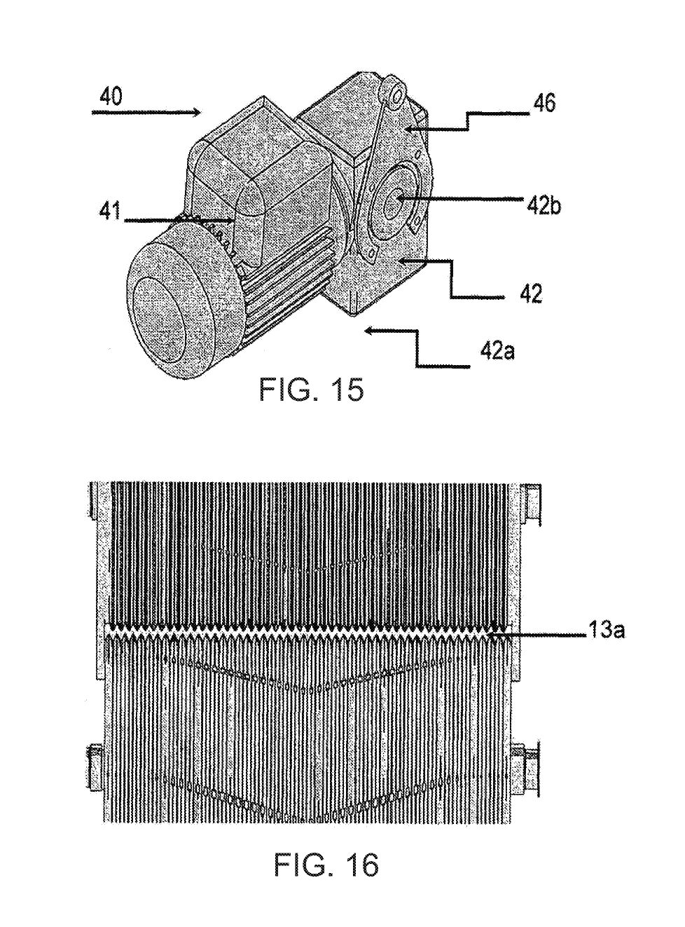

The bearing block's carcass (31) has a first tensioning arm (36) as shown in FIG. 11, FIG. 13 and FIG. 14. As shown in FIG. 11, the gear motor's carcass (42a) has a tensioning second arm (46) mirroring the first tensioning arm (36) to anchor the gear motor (40) at the bearing block's structure (30) and avoid the rotation of the gear motor (40) and have the necessary support to apply the torque. Each tensioning arm (36, 46) consists of an enlarged piece with a flange in one of its ends to arrange respectively one in the bearing block (30) and the other at the gear motor's carcass (42a). At the opposite ends of each of the tensioning arms (36, 46) there is a first ball and socket joint (37), which allows the alternative movement, and a second ball and socket joint (47), which allows a spherical movement. A cap screw (49) extends between said ball and socket joints (37,47), so that in one of its ends it has the suitable elements which once assembled allow a one degree of freedom spherical movement in the second ball and socket joint (47) and its opposite end which once arranged allow it a movement of a degree of alternative lineal freedom over its longitudinal axis, so that an alternative movement is allowed for the cap screw (49); with the above, in this arrangement of tensioning arms (36, 46) two degrees of freedom are achieved; one spherical and another lineal.

The cap screw (49) is of suitable features to absorb the efforts of cutting to which it is subject, when the mill (1) is in operation and the rollers' axis floating movements (10). The placing of the cap screw (49) is achieved by known elements such as screws and similar elements which allow the limiting of the coaxial movement in one of its ends, but allows the free movement of both ball and socket joints, thereby the misalignments generated with the functioning of the mill (1) are absorbed by these ball and socket joints, and the rotation of the gear motor (40) over the axis of the exit arrow (not illustrated) is avoided and the application of its torque over the rollers (10) is obtained.

The placing of the bearing blocks (30) at the rollers' bases (21), is carried out by known elements, for example: the bearing blocks of the top roller (10b) have an arrangement which allows their vertical movement through a dock element, which provides strength towards the roller, improving the squeezing of the material; the bearing blocks of the bottom rollers (10a) have some screws (24), which by way of a lid (24a) allow the placing of the rollers (10) to adjust their separation, which when defined the screws are adjusted to maintain the placing as shown in FIGS. 4 and 5.

The arrangement of the hollow arrow-type gear motor (40), comprises an electrical motor (41) like those known in the art and a gear speed reducer (42) that comprises the gear motor carcass (42a), this arrangement with suitable power and speed, passes the power in an independent manner to the rollers, the gear motors have the feature of being hollow arrow (42b), that way the arrow of the roller can be mounted (12) by clamping discs (not illustrated) known in the art.

### BEST WAY TO CARRY OUT THE INVENTION

The structure developed for the mill (1) of the present invention has the objective of compensating for the misalignment between the rotation axes of the rollers (10) when these process the plants to extract the juice contained therein.

In the operation, when the arrangement of rollers (10) is rotating, the material to be processed (not illustrated) is fed between a pair of rollers, specifically between one of the bottom rollers (10a) and the top roller (10b), so that a portion of the material is held by the teeth (13) in the periphery of the rolls (10); due to the shape of the transversal cut (15) created by the teeth pattern (13) the material to be processed is directed towards the center of the length of said rollers (10), since the material is pulled from the longitudinal ends by the tips (15a) from the transversal cut (15) found here and subsequently the traction with the tips (15a) of the teeth (13) which are found consecutively towards the center of the length of the rollers (10). This effect causes the material to be processed be found at the center of the roller (10), reducing the misalignment between the adjacent rollers (10). The shape of the transversal cut (15) directs the extracted juice from the plant towards the center of the roller (10) so that there is a better dispersion of the juice when it is extracted from the fibers, improving its collecting to a more specific zone.

The random movement of the material to be processed entering between the rollers (10) or some predetermined or random misalignment at the time of arranging the mill (1), can generate a misalignment between the axis of rotation of the adjacent rollers (10), and so, the tensioning arm (36, 46) allows the flotation of the rollers' (10) axis alignment, since the ball and socket joints (37, 47) allow the flotation of the axis alignment thanks to the spherical and lineal degrees of freedom of the cap screw (49). With the above, the output axis of the gear motor (40) is always aligned with the axis of the roller (10) and at the same time the anchorage of the suitable gear motor (40) with the supporting structure (20), as the movement of the gear motor (40) will be followed by the bearing blocks (30). In this way, the total power in the output arrow of this gear motor (40) will be applied to the rollers (10) independently of the alignment condition of the rotation axis, eliminating the loss of efficiency by the oscillatory movement of the rollers (10). The bearing blocks (30) are important to allow the flotation of the rollers' (10) rotation axis, as these allow an spherical movement in the support of the roller's arrow (12) when there is a cause of misalignment from its rotation axis, which is achieved by the bearing (35) of each of them being of ball and socket joint-type, so that the carcass (31) of the bearing block (30) by the sliding of the reduction of bearing block (31a) in a linear movement in the sliders (21a) from the roller's base (21). The lubrication of each of the bearings (35) is carried out by a lubricant contained in the carcass (31) and dust covers (34) as the shape of the bellow absorbs the spherical movements of the roller's arrow (12) in the bearing block (30).

The structure of this mill (1) takes advantage of the hardiness of its structure for the application of the power suitably on the rollers (10) as the motors are of a lesser capacity since the total of their power is applied to each of the rollers, reducing the loss of efficiency by a more direct application. The application in each roller allows the installation of a gear motor of less capacity as the total of the given power is applied directly on them, so the energy demand can be reduced for the same number of processing phases in the plants to be processed which allows the installation of a higher number of extraction stages and in this way the juice collection can be increased from a certain volume of material and obtain a final product with better quality indexes.

1. A mill (1) for plants comprising an arrangement of rollers (10), with a central bearing (11) having a series of teeth (13) and roller arrows (12), also a support structure (20) for the arrangement of rollers (10), bearing blocks (30) that hold the roller's arrow (12), said mill characterized in that: the roller (10) has a pattern of a transversal cut (15) distanced between each other and over the series of teeth (13) that extends in a tilted manner from each border of the central bearing (11) and converges at the center of the roller (10) in the shape of an angled line making a wall with an acute angle at the superior border of the tooth (13) which creates a tip (15a) and in the teeth's (13) crests there is a coarse finish known as knurling; the support structure (20) is made up of a pair of rollers' bases (21), an inferior frame (22) and superior beams (23), wherein each of these rollers' bases (21) has an arrangement of sliders (21a) where the bearing blocks (30) are housed; the bearing blocks (30) consist of a bearing block carcass (31) of suitable dimension and material with a reduction of bearing block (31a) that works as guide to slide at the borders of the sliders (21a) of the rollers' bases (21), a dust cover (34) in each end of the bearing box (32) and an auto-aligning bearing (35); also a first tensioning arm (36) in the bearing block's carcass (31) and a second tensioning arm (46) in the gear motor's carcass (40) to anchor the gear motor in the support structure (20), where each tensioning arm (36,46) has a flange in each of its ends to bind respectively to the bearing block's carcass (31) and to the gear motor's carcass (42a), also a ball and socket joint (37,47) in the opposite ends, where a first ball and socket joint (37) allows an alternative movement and a second ball and socket joint (47) that allows an spherical movement; a cap screw (49) that extends between said ball and socket joints (37,47) with suitable elements to allow a movement of one degree of spherical freedom at the second ball and socket joint (47) and at its opposite end, elements which allow a movement of one degree of alternative lineal freedom over its longitudinal axis; a gear motor (40) that is coupled to each roller (10) and is anchored at the support structure (20).

2. A mill (1) for plants of claim 1, wherein at the pair of top and bottom rollers (10b) (10a) exposed at the input of the mill (1) the transversal cut's vertex (15) in one of them is directed in opposite directions from the transversal cut's vertex (15) of the adjacent roller (10), and at the pair of top and bottom rollers (10b) (10a) exposed at the output of the mill (1) the transversal cut's vertex (15) in one of them is directed to the same direction to the transversal cut (15) of the adjacent roller (10).

3. A mill (1) for plants of claim 1, wherein the series of teeth (13) at the central bearing (11) parts from an initial bearing (14), which consists of perimetral rings, with a transversal section in the shape of a trapeze.

4. A mill (1) for plants of claim 1, wherein the coarse finish can be in the faces of the teeth (13).

5. A mill (1) for plants of claim 1, wherein the transversal cut (15) does not interfere with the central bearing (1), so that an angled line such as that of a tire can be obtained.

6. A mill (1) for plants of claim 1, wherein each roller's arrow (12) creates arrow spikes (16) which settle in the bearing blocks (30) that hold the roller (10) so it can roll.

7. A mill (1) for plants of claim 1, wherein the bearing blocks (30) at the roller's bases (21) hold an end of the roller's arrow (12).

8. A mill (1) for plants of claim 1, wherein at each end of the rollers (10) are the roller's bases (21) located in a parallel manner and symmetric, wherein the sliders (21a) align in a coaxial manner and said roller's bases (21) are bound in the inferior border with the inferior frame (22) and in the superior border by the superior beams (23) in a suitable manner to provide the support and rigidity necessary to the support structure (20) and of suitable features to absorb the efforts to which the mill (1) is subjected.

9. A mill (1) for plants of claim 1, wherein the rollers' bases (21) allow the placing of a pair of bottom rollers (10a) in a first inferior plane and in between these inferior rollers (10a) there is a third top roller (10b) in a superior plane, resulting in a triangular arrangement of the rollers (10) so that there is an inference of dimensions between the perimeters of the teeth (13) of the bottom rollers (10a) housed in the reductions (13a) of the top roller (10b).

10. A mill (1) for plants of claim 1, wherein the bearing blocks' carcass (31) has a bearing box (32) in its interior, of a suitable dimension to host a bearing (35).

11. A mill (1) for plants of claim 1, wherein the bearing box (32) comprises a bearing seat (32a) consisting of a basin with a diameter that allows the adjustment of the bearing (35) in its interior and an oil box (32b) of suitable dimension to contain a certain quantity of lubricant and of a larger diameter that allows the free pass of the bearing (35) up to its position of operation; a lock opening (32c) to place a lock (not illustrated) to maintain the position of the bearing inside the bearing box (32) and in a first end of the bearing box (32) there is a flange of larger diameter (32d) that limits the pass of the bearing (35) through it.

12. A mill (1) for plants of claim 1, wherein each of the dust covers (34) are enlarged with a body in the shape of a bellow with a first end of suitable dimension and features to be hosted in the opening of the bearing box (32) and a second end with a suitable opening to adjust in a sliding manner to the end of the arrow spikes (16).

13. A mill (1) for plants of claim 1, wherein the bearing (35) is of ball and socket joint-type.

14. A mill (1) for plants of claim 1, wherein the placing of the bearing blocks (30) at the rollers' bases (21) is carried out by known elements.

15. A mill (1) for plants of claim 1, wherein the placing of the bearing blocks (30) of the top roller (10b) has an arrangement that allows its vertical movement through a spring and the bearing blocks of the bottom rollers (10a) have some pushing screws (24) which through a lid (24a) allow the placing of the rollers (10) to adjust their spacing; once defined, the screws are adjusted to keep the rollers in place.

16. A mill (1) for plants of claim 1, wherein the cap screw (49) is of suitable features to absorb the efforts of torsion to which the mill (1) is subject when in operation and of the floating movements of the rollers' axis (10).

17. A mill (1) for plants of claim 1, wherein the placing of the cap screw (49) is carried out by known elements such as screws and similar that allow the coaxial movement in one of its ends, but allows the free movement of both ball and socket joints.

18. A mill (1) for plants of claim 1, wherein the arrangement of the gear motor (49) is of the hollow arrow-type.
